(19) United States
(12) Patent Application Publication
(10) Pub. No.: US 2024/0386694 A1
(43) Pub. Date: Nov. 21, 2024

(54) METHOD FOR ACQUIRING MULTISPECTRAL IMAGES AND PANCHROMATIC THUMBNAIL IMAGES

(71) Applicant: SAFRAN REOSC, SAINT PIERRE DU PERRAY (FR)

(72) Inventor: Jean-Louis CAREL, MOISSY-CRAMAYEL (FR)

(21) Appl. No.: 18/691,729

(22) PCT Filed: Sep. 14, 2022
(86) PCT No.: PCT/EP2022/075527

§ 371 Date: Mar. 13, 2024

(30) Foreign Application Priority Data
Sep. 23, 2021 (FR) FR2110050

(51) Int. Cl. G06V 10/58; G06T 7/00

(52) U.S. Cl. CPC G06V 10/58; G06T 7/0004; G06T 2207/10036

(57) ABSTRACT

A method for acquiring multispectral images and panchromatic thumbnail images by a matrix-array sensor installed in a carrier travelling above a scene and covered with a filter having a panchromatic filtering band followed by at least two spectral filtering bands. The panchromatic and spectral filtering bands are parallel and extending in a direction that is substantially orthogonal to the movement of the carrier. The method includes: a) acquiring a multispectral image at least through the two spectral filtering bands; b) transferring the multispectral image; c) acquiring a panchromatic thumbnail image only through the panchromatic filtering band; d) transferring the panchromatic thumbnail image; e) as long as the scene is not within another of the filtering bands, repeating steps c) and d); and f) repeating steps a) to e) until a multispectral image of the scene through each filtering band is obtained. An acquisition device and a vehicle using the method.

The invention relates to the field of spatial imaging, and more specifically, a method for acquiring multispectral images and panchromatic images intended for the observation of the Earth.

### BACKGROUND OF THE INVENTION

Spatial imaging, also called satellite imaging, means taking images from space by matrix-array sensors placed on satellites. There are mainly three techniques for acquiring spatial images respectively called “push broom”, “single shot” and “push frame”.

The “push broom” technique, also called “scanning” consists of using at least one CCD (Charge Coupled Device) bar-type linear sensor, and the movement of the satellite around the Earth to construct strips of an image. Its operating principle is identical to that of scanners and photocopiers which comprise a reading bar moved along the page to be digitalised. This technique is typically implemented on large satellites for observing the Earth such as satellites called SPOT and Pleiades. The linear sensor can be equipped with a filter making it possible for spectral images to be taken.

The “single shot” technique consists of using a matrix-array sensor to construct a 2D image in one single pass. Its operating principle is identical to that of cameras and is frequently used on microsatellites and nanosatellites. If it is possible to construct colour images by equipping, for example, the matrix-array sensor with a Bayer filter, this acquisition technique makes it difficult to take multispectral images and has a low flux and a high integration time leading to producing the blur on the image.

The “push frame” technique combines the “push broom” technique with the “frame” technique. It consists of using a matrix-array sensor to acquire images offset over time along a vertical axis of the sensor, due to the movement of the satellite around the Earth. This technique makes it possible to take multispectral and panchromatic images by placing before the sensor, a filter having several high horizontal bands of a few hundred pixels and extending over the entire width of the sensor, each band covering a different wavelength interval. The acquisitions are offset over time such that the resulting spatial offsetting is slightly less than the height of the bands of the filter, such that for each spectral band, a complete image of a scene can be reconstituted by concatenation.

It has been considered to improve the resolution of the complete panchromatic image by achieving a large number of acquisitions very close over time, such that these successive acquisitions are highly covered by a non-whole number of pixels and enable the implementation of a so-called “super-resolution” processing method.

However, achieving a large number of acquisitions is based on the possibility of having both a sensor having a high acquisition speed and a particularly efficient electronic acquisition unit.

What is more, such an acquisition generates a significant quantity of data, that it is difficult to transmit to a reception station on Earth, and which, subsequently, involves a processing of acquisitions onboard the satellite.

### Aim of the Invention

The invention therefore aims to propose a method for acquiring multispectral images and panchromatic images, at least partially overcoming the abovementioned problems.

### SUMMARY OF THE INVENTION

To this end, the invention proposes a method for acquiring multispectral images and panchromatic thumbnail images by a monochrome matrix-array sensor installed in a mobile carrier in a direction of movement above a space comprising a scene to be observed. The matrix-array sensor has a field covering an extent of the space greater than the scene in the direction of movement and is provided with a filter having a panchromatic filtering band followed by at least two spectral filtering bands, each covering a different wavelength interval. The panchromatic filtering band and the spectral filtering bands are parallel and extending in a direction substantially orthogonal to the direction of movement of the carrier.

According to the invention, the method comprises the following steps:
a) when the scene is within one of the filtering bands of the filter, acquiring a multispectral image by the sensor at least through the two spectral filtering bands;
b) transferring the multispectral image to an electronic processing unit;
c) acquiring a panchromatic thumbnail image by the sensor only through the panchromatic filtering band;
d) transferring the panchromatic thumbnail image to the electronic processing unit;
e) as long as the scene is not within another of the filtering bands, repeating steps c) and d); and
f) repeating steps a) to e) until a multispectral image of the scene through each spectral filtering band is obtained.

Thus, the time necessary for the scene to pass from one to the other of the spectral filtering bands is used to acquire panchromatic thumbnail images being partially covered and on which a so-called “super-resolution” processing method can be implemented, enabling the generation of a high-resolution panchromatic image.

Particularly, the acquisition of the multispectral image achieved in step a) is done through the panchromatic filtering band and the spectral filtering bands, which has the effect of increasing the number of acquisitions of panchromatic thumbnail images, and therefore the resolution of the panchromatic image coming from the “super-resolution” processing method.

Particularly, the acquisition of the multispectral image achieved in step a) is done only through the spectral filtering bands.

Particularly, the acquisition of the multispectral image achieved in step a) is done in “2×2 binning” mode.

Particularly, the method comprises the steps of: correcting the defects of all the thumbnail images of a band over a given duration, aligning said thumbnail images, merging the thumbnail images to form a reconstituted image and cropping the reconstituted image to preserve a useful field.

The invention also relates to an image acquisition device to be mounted on a vehicle. The device comprises an image sensor connected to an electronic control unit programmed to implement such a method.

The invention also relates to a vehicle equipped with such an acquisition device.

### BRIEF DESCRIPTION OF THE DRAWINGS

The invention will be best understood in the light of the description below, which is purely illustrative and non-limiting, and must be read regarding the accompanying figures, among which:

FIG. 1 is a schematic view of the method according to a particular embodiment of the invention;

FIG. 2 is a schematic view of the carrier equipped with the matrix-array sensor used in the method illustrated in FIG. 1;

FIG. 3 is a schematic view of the filter equipping the matrix-array sensor used in the method illustrated in FIG. 1;

FIG. 4 represents different successive acquisitions achieved by the sensor according to the method illustrated in FIG. 1; and

FIG. 5 represents a chronogram of the different acquisitions achieved by the sensor according to the method illustrated in FIG. 1.

### DETAILED DESCRIPTION OF THE INVENTION

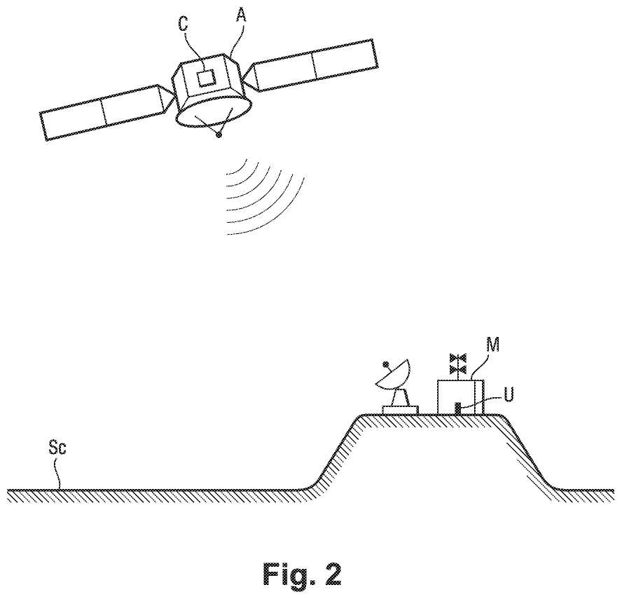

In reference to FIG. 2, a monochrome matrix-array sensor C is installed in a carrier A travelling above a space having a scene Sc to be observed. The carrier A is, in this case, a satellite orbiting around the Earth and the space having the scene Sc to be observed is the Earth's surface. The satellite emits image signals to a station M on the ground by radiocommunication means in a manner known per se.

The sensor C comprises a matrix-array detection area having unit detectors, or pixels (from “picture element”), arranged in lines extending along a horizontal axis X substantially perpendicular to a direction of movement of the carrier A and in columns extending along an axis Y substantially parallel to the direction of movement of the carrier A. The sensor C has, in this case, a resolution of 5120×5120 pixels, that is around 26 megapixels, and is preferably of the CMOS (Complementary Metal Oxide Semi-Conductor) type. The sensor C is, in this case, disposed behind an optical unit comprising one or more lenses and/or one or more mirrors, and thus has a field covering an extent of the Earth's surface greater than the scene to be observed.

An electronic processing unit U connected to the sensor C receives signals generated by the different pixels and provides, from these signals, data representative of an image acquired by the sensor. The signals are representative of the power of a luminous flux received by each pixel and will be translated into levels of grey in the images created from the signals of the sensor. The electronic processing unit U comprises, for example, at least one calculation module, like a processor, and a memory containing a computerised program for controlling the sensor and for processing the image which can be executed by the processor. The computerised program comprises instructions arranged to implement the method of the invention.

The sensor C is equipped with the “Area Of Interest” (AOI) functionality, which makes it possible to select and to only read one part of the matrix-array area of said sensor C, such as a windowing. Such a functionality has the advantage of reducing the numbers of pixels read, and therefore of increasing the acquisition speed of the sensor and of decreasing the quantity of data transmitted to the electronic processing unit U. Indeed, transferring data between the sensor C and the electronic processing unit U is done typically by one or more LVDS (Low Voltage Differential Signalling) channels, in digital form and the time for transferring an image is proportional to the quantity of data, in other words, to the number of pixels used, and therefore to the dimensions of the area of interest.

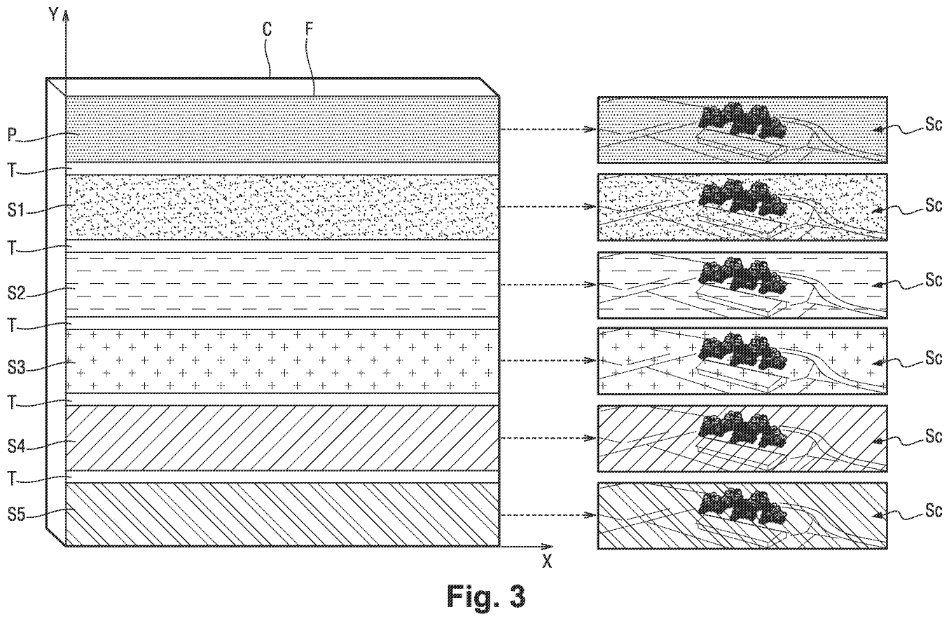

As illustrated in FIG. 3, the sensor C is covered with a filter F having six rectangular-shaped filtering bands P, S1, S2, S3, S4, S5 and are each spaced apart by a transition area T. The filtering bands P, S1, S2, S3, S4, S5 have substantially identical dimensions and extending along the axis X over the entire width of the sensor C. Each filtering band P, S1, S2, S3, S4, S5 covers a different wavelength interval and has, in this case, a height of around 800 pixels along the axis Y. The transition areas T are substantially identical and have, in this case, a height equal to a few pixels.

The first filtering band P is a panchromatic filtering band, in other words, a band transmitting all of the wavelengths of the visible range of the light spectrum and blocking all other wavelengths. The five other filtering bands S1, S2, S3, S4, S5 are spectral filtering bands, in other words, bands each transmitting a predetermined colour of the light spectrum and absorbing all the other colours. For example, the red colour can be chosen for the second band S1, the magenta colour for the third band S2, the orange colour for the fourth band S3, the green colour for the fifth band S4 and the blue colour for the sixth band S5.

Thus, each filtering band P, S1, S2, S3, S4, S5 corresponds to a different wavelength interval and partially covers the matrix-array area of detection of the sensor.

By travelling in the same direction as the carrier A, the sensor C scans the scene Sc along the axis Y, which, seen from the sensor C, has dimensions less than those of the filtering bands P, S1, S2, S3, S4, S5, such that the filter F enables the acquisition of an image of the scene Sc for different wavelengths. For that, it is necessary to wait for the scene Sc to pass from one filtering band to the other to trigger the acquisition of an image by the sensor C. The waiting time depends on the movement speed of the carrier A and is, in this case, equal to 119 milliseconds.

The principle of the invention is to benefit from this waiting time to make panchromatic thumbnail images from the scene Sc by way of the panchromatic filtering band P of the filter F.

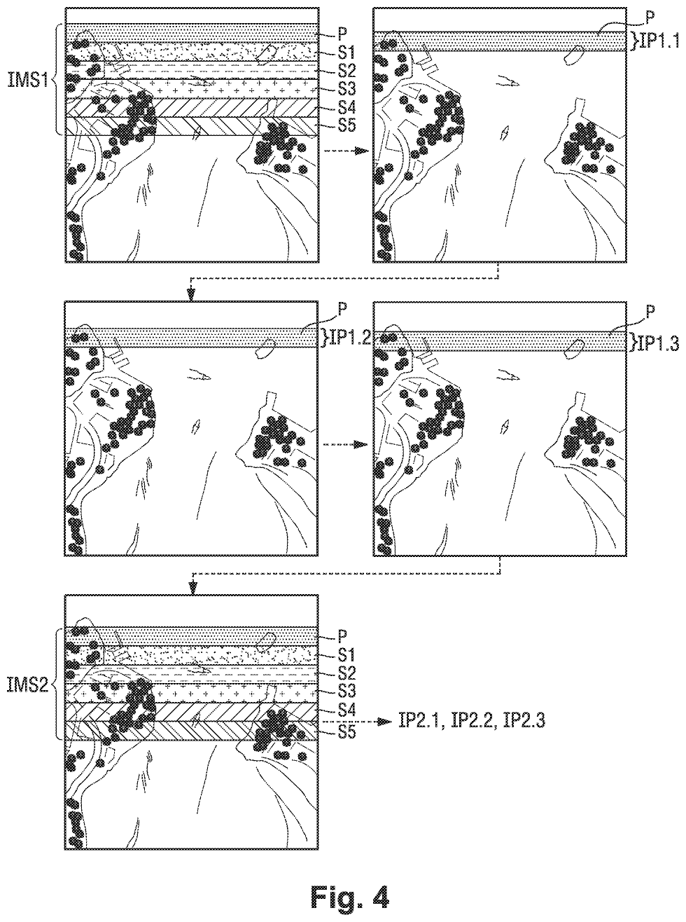

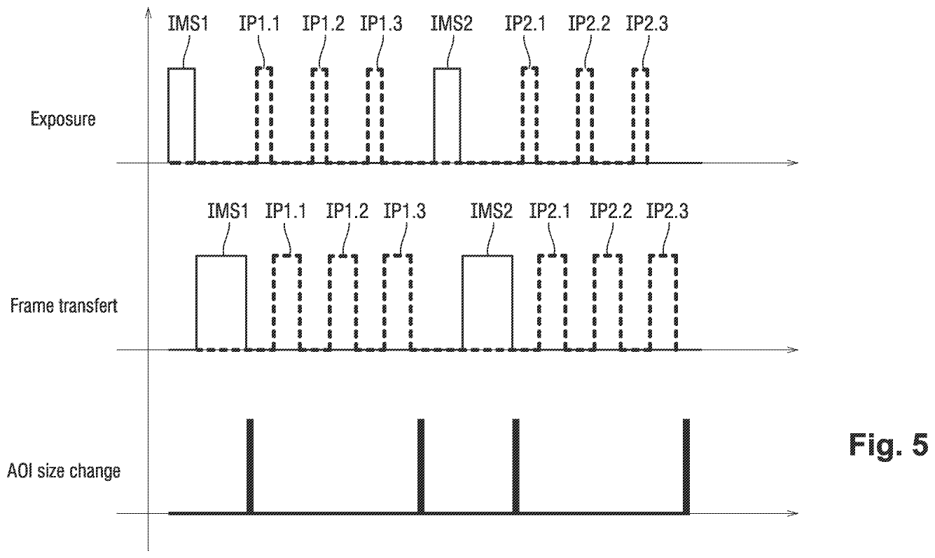

FIGS. 4 and 5 illustrate a particular embodiment of the invention, which will now be detailed.

During the movement of the carrier A, the scene Sc appears for the first time in one of the filtering bands P, S1, S2, S3, S4, S5, covering the sensor, namely in this case, the panchromatic filtering band P. As soon as the scene Sc is fully within the panchromatic filtering band P, the acquisition of a first multispectral image IMS1 is achieved by the sensor C through all of the filtering bands P, S1, S2, S3, S4, S5, in other words, through the panchromatic filtering band P and the spectral filtering bands S1, S2, S3, S4, S5 (step 10). It is thus understood that the area of interest of the sensor is maximum and covers all of the filtering bands P, S1, S2, S3, S4, S5.

The multispectral image IMS1 is then transferred to the electronic processing unit U (step 20), then the area of interest of the sensor is modified via a suitable connection (connection of the RS232, I2C, SPI series or equivalent type), so as to only select the pixels of the matrix-array area of the sensor C corresponding to the panchromatic filtering band P. The transfer time is, in this case, equal to 38 milliseconds.

During this time, the sensor C continues to scan the scene Sc. While the scene Sc is not fully within the following filtering band, namely in this case, the second filtering band S1, the acquisition of first panchromatic images is achieved by the sensor C through the panchromatic filtering band P (step 30) progressively from their transfer to the electronic processing unit U (step 40).

In reference to FIG. 5, the acquisition speed of the sensor C and the speed at which the signals generated by the pixels are transmitted from the sensor C to the electronic processing unit U enable, in this case, the acquisition and the transfer of three first panchromatic thumbnail images IP1.1, IP1.2, IP1.3, before the scene Sc is not fully within the filtering band S1. The acquisition time and the transfer time are, in this case, respectively 18 milliseconds and 4.8 milliseconds for each of the first panchromatic thumbnail images IP1.1, IP1.2, IP1.3. The first panchromatic thumbnail images IP1.1, IP1.2, IP1.3 are highly covered with a non-whole number of pixels.

The area of interest of the sensor is then modified again, so as to become maximum again and cover all of the filtering bands P, S1, S2, S3, S4, S5.

As soon as the scene Sc is fully within the filtering band S1, the acquisition of a second multispectral image IMS2 is achieved by the sensor through all of the filtering bands P, S1, S2, S3, S4, S5 (step 10), then the second multispectral image IMS2 is transferred to the electronic processing unit U (step 20). Steps 30 and 40 are thus repeated (steps 50) and result in the acquisition and in the transfer of three second panchromatic thumbnail images IP2.1, IP2.2, IP2.3, before the scene Sc is not fully within the third filtering band S2. Like the first panchromatic thumbnail images IP1.1, IP1.2, IP1.3, the second panchromatic thumbnail images IP2.1, IP2.2, IP2.3 are highly covered with a non-whole number of pixels. The second multispectral image IMS2 itself slightly covers the first multispectral image IMS1 of a generally non-whole number of pixels.

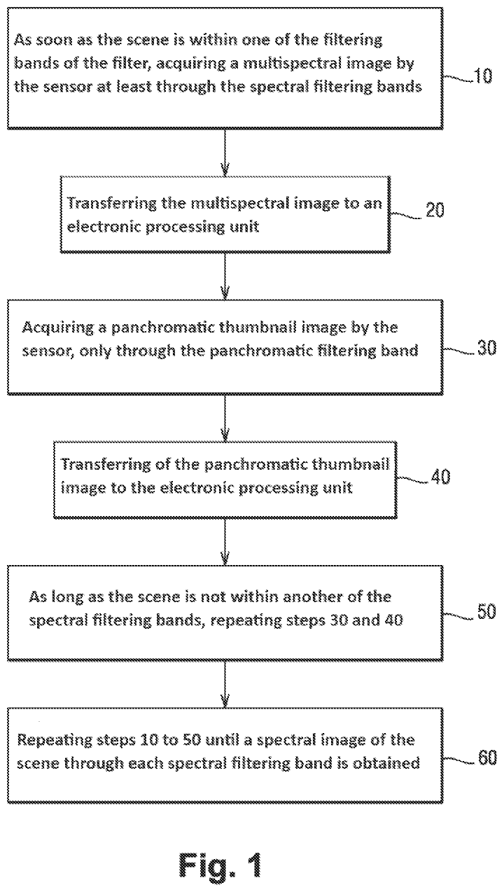

As illustrated in FIG. 1, steps 10 to 50 are finally repeated until a multispectral image of the scene Sc through each of the filtering bands P, S1, S2, S3, S4, S5 is obtained (step 60).

FIG. 5 illustrates, in the form of a chronogram, all of the steps 10, 20, 30, 40, 50, 50 of the method for acquiring multispectral images IMS1, IMS2 and panchromatic thumbnail images IP1.1, IP1.2, IP1.3, IP2.1, IP2.2, IP2.3.

The filtering bands P, S1, S2, S3, S4, S5 having identical dimensions, it results from this, that in terms of quantity of data, a panchromatic thumbnail image IP1.1, IP1.2, IP1.3, IP2.1, IP2.2, IP2.3 is, in this case, six times lighter than a multispectral image IMS1, IMS2. It will thus be noted that capturing three panchromatic thumbnail images IP1.1, IP1.2, IP1.3, IP2.1, IP2.2, IP2.3 in addition to a multispectral image IMS1, IMS2 only multiplies by 1.5 the quantity of data transferred to the electronic processing unit U, while enabling the construction of a high-resolution panchromatic image from the multispectral images IMS1, IMS2 and from the panchromatic thumbnail images IP1.1, IP1.2, IP1.3, IP2.1, IP2.2, IP2.3 acquired by the sensor C via a so-called “super-resolution” processing algorithm. “Super-resolution” algorithms are themselves known, and are not detailed further, in this case.

The processing of multispectral images IMS1, IMS2 and of panchromatic thumbnail images IP1.1, IP1.2, IP1.3, IP2.1, IP2.2, IP2.3 by the electronic processing unit U will now be detailed.

Each multispectral image IMS1, IMS2 is first cut into six thumbnail images IMS1.1, IMS1.2 . . . . IMS1.6, IMS2.1, IMS2.2 . . . . IMS2.6, each corresponding to one of the filtering bands P, S1, S2, S3, S4, S5 after removal of the transition areas T. Thus, for each multispectral image IMS1, IMS2, a panchromatic thumbnail image IMS1.1, IMS2.1 and five spectral thumbnail images IMS1.2, IMS1.3 . . . . IMS1.6, IMS2.2, IMS2.3 . . . . IMS2.6 are obtained.

The thumbnail images IMS1.1, IMS1.2 . . . . IMS1.6, IMS2.1, IMS2.2 . . . . IMS2.6 are optionally corrected of defects, such as distortion, then those coming from one same filtering band are concatenated by aligning them on a whole pixel after having calculated their coverage. The calculation of the coverage can arise from knowledge beforehand of the coverage obtained, for example, from navigation data (GPS position, aiming angle, etc.) or from an analysis of a common area between the thumbnail images such as a correlation of images.

In the case where the coverage is equal to a non-whole number of pixels, the whole part of the number of pixels is used for the concatenation, and the fractional part is added to the distortion defects to be corrected. Generally, there is also a slight lateral offsetting of the thumbnail images along the axis X, and optionally a slight rotatable offsetting in the plane XY.

The common pixels between two thumbnail images IMS1.1, IMS1.2 . . . . IMS1.6, IMS2.1, IMS2.2 . . . . IMS2.6 are averaged with an optional weighting to alleviate the transition between these two thumbnail images.

The images generated by concatenation, also called concatenated or reconstituted images, are cropped, in particular in order to remove the stepped areas caused by the lateral offsetting the thumbnail images from one another.

Finally, as many concatenated images as filtering bands are obtained, that is, in this case, six concatenated images, including one panchromatic image and five spectral images.

All of the panchromatic thumbnail images IP1.1, IP1.2, IP1.3, IP2.1, IP2.2, IP2.3 obtained between two acquisitions of multispectral images are cropped then grouped together in acquisition rows between two multispectral images IMS1, IMS2. The panchromatic thumbnail images IP1.2, IP1.3, IP2.1, IP2.2, IP2.3 of the same row are thus, in the same way as the panchromatic thumbnail images IMS1.1, IMS2.1 coming from the multispectral images IMS1, IMS2, corrected of defects and concatenated.

Thus, as many concatenated images are obtained as panchromatic thumbnail images obtained between two acquisitions of multispectral images, that is, in this case, three panchromatic concatenated images, to which the panchromatic concatenated image is added, coming from the multispectral images.

All of the panchromatic concatenated images are thus processed by the “super-resolution” algorithm as if these were native images to generate a panchromatic high-resolution image of the scene Sc, and from what surrounds it.

The high-resolution image is then cropped so as to correspond to the concatenated images coming from the multispectral images.

It will be noted that the processing of images and thumbnail images can be done on the vehicle A or alternatively, in a station on the ground. The latter case is made possible by the fact that the volume of data to transmit is limited by the implementation of the acquisition method of the invention.

Naturally, the invention is not limited to the embodiment described, but surrounds any variant entering into the field of the invention, such as defined by the claims.

Although, in this case, the acquisition of multispectral images IMS1, IMS2 is achieved through all of the filtering bands P, S1, S2, S3, S4, S5, S6, it can also be done only through only some of the filtering bands, for example, through the spectral filtering bands S1, S2, S3, S4, S5, S6.

Preferably, the mode for the “2×2 binning” of the sensor C can be used, which consists of grouping together, during the acquisition, the signal of four adjacent pixels, and therefore of decreasing the resolution of the multispectral images by two. Subsequently, the acquisition and transfer time will be substantially divided by four, which will enable the acquisition of a large number of panchromatic thumbnail images in between two acquisitions of multispectral images, the acquisition of the panchromatic images using the conventional mode of the sensor C (“1×1 binning”). Generally, the mode for the “N×M binning” of the sensor C can be used with, for example, N=M=3 (if the sensor C enables this).

Although, in this case, the panchromatic thumbnail images IP1.1, IP1.2, IP1.3, IP2.1, IP2.2, IP2.3 are used to increase the resolution of the panchromatic image coming from the multispectral images IMS1, IMS2, they can also be used to increase its signal-to-noise ratio (SNR), by performing a simple summing of said panchromatic thumbnail images.

A different exposure time for acquiring panchromatic thumbnail images (IP1.1, IP1.2, IP1.3, IP2.1, IP2.2, IP2.3) and acquiring multispectral images (IMS1, IMS2) can be used to increase their signal-to-noise ratio (SNR).

The method of the invention can naturally be used for observing planets other than Earth.

More generally, the method of the invention can be used in a field other than spatial imaging, as soon as the carrier A can generate a scanning of the scene Sc by the sensor C, and that said sensor C is sensitive in wavelength intervals which can be selected by a filter, and that its area of interest can be configured: observation of the ground by a drone, by a high-altitude pseudo-satellite of the HAPS (High-Altitude Platform Station) type.

The carrier A can be an aircraft such as an aeroplane, a space vehicle or a satellite.

Although, in this case, the transfer of data between the sensor C and the electronic processing unit U is done by one or more LVDS (Low Voltage Differential Signalling) channels, it can also be done by one or more sub-LVDS, MIPI-CSI2 (Mobile Industry Processor Interface-Camera Serial Interface 2), Camera Link, CXP (CoaXPress), etc channels.

1. A method for acquiring multispectral images and panchromatic thumbnail images by a monochrome matrix-array sensor installed in a mobile carrier in a direction of movement above a space comprising a scene to be observed, the matrix-array sensor having a field covering an extent of the space greater than the scene in the direction of movement and the matrix-array sensor being provided with a filter having a panchromatic filtering band followed by at least two spectral filtering bands, each covering a different wavelength interval, the panchromatic filtering band and the spectral filtering bands being parallel and extending in a direction substantially orthogonal to the direction of movement, characterised in that the method comprises the following steps:
a) when the scene is within one of the filtering bands of the filter, acquiring a multispectral image by the sensor at least through the two spectral filtering bands;
b) transferring the multispectral image to an electronic processing unit;
c) acquiring a panchromatic thumbnail image by the sensor, only through the panchromatic filtering band;
d) transferring the panchromatic thumbnail image to the electronic processing unit;
e) as long as the scene is not within another of the filtering bands, repeating steps c) and d); and
f) repeating steps a) to e) until a multispectral image of the scene through each spectral filtering band is obtained.

2. The method according to claim 1, wherein the acquisition of the multispectral image achieved in step a) is done through the panchromatic filtering band and the spectral filtering bands.

3. The method according to claim 1, wherein the acquisition of the multispectral image achieved in step a) is done only through the spectral filtering bands.

4. The method according to claim 1, wherein the acquisition of the multispectral image achieved in step a) is done in “2×2 binning” mode.

5. The method according to claim 1, comprising the steps of:
correcting the defects of all the thumbnail images of a band over a given duration, aligning said thumbnail images, merging the thumbnail images to form a reconstituted image and to crop the reconstituted image to preserve a useful field.

6. An image acquisition device arranged to be mounted on a vehicle, comprising an image sensor connected to an electronic control unit programmed to implement the method according to claim 1.

7. A vehicle equipped with an image acquisition device according to claim 6.
